(19) United States
(12) Patent Application Publication
(10) Pub. No.: US 2016/0324710 A1
(43) Pub. Date: Nov. 10, 2016

(54) Chiropractic Table

(71) Applicant: Brian Caruana, Sydney (AU)

(72) Inventor: Brian Caruana, Sydney (AU)

(21) Appl. No.: 14/706,918

(22) Filed: May 7, 2015

(51) Int. Cl. A61G 13/00

(52) U.S. Cl. CPC A61G 13/009; A61G 2200/32

(57) ABSTRACT

The disclosed Chiropractic Table is the Chiropractic Table where the separation of the table surface is Vertical. The two sections will fold down inwards supported by adjustable spring loaded hinges. When the chiropractor will use both hands and push on your back. With the Vertical Separation, the chiropractor will be able to adjust your entire spinal cord and pelvis area. The separation section and the spinal cord are both parallel with each other. The result will be a smoother down ward pressure on the spinal cord and pelvis area. The chiropractor has the option to change the head rest to another head style.

For many years I have been suffering from Chronic Back and Neck Pain. Where the muscles become very stiff and sore, and the only way to relief the pain is to visit a Chiropractor. They will start with deep hard hand massage. To loosen up your tight muscles from your back and neck. Then the Chiropractor will ask you to lay face down on a Chiropractic Table. To adjust your spine and shoulders to normal position.

The conventional Chiropractic Table has horizontal separation sections. Where the Chiropractor will raise the selected section on one side and with both hands will push down hard on your back. Resulting the raised section will fold down back to its original place. And that part of your back will be adjusted to its normal position. The way this method is done when they push hard on your back, the result is a hard collapse of your back and spine. This design is very rigid and can become a problem to the Spinal Cord. And only a few sections of your back and spin are adjusted. The other areas of your back and spine that are missed will be adjusted, by the Chiropractor manually twisting your back and spine.

The invention may be better understood with reference to the illustrations of embodiments of the invention which:

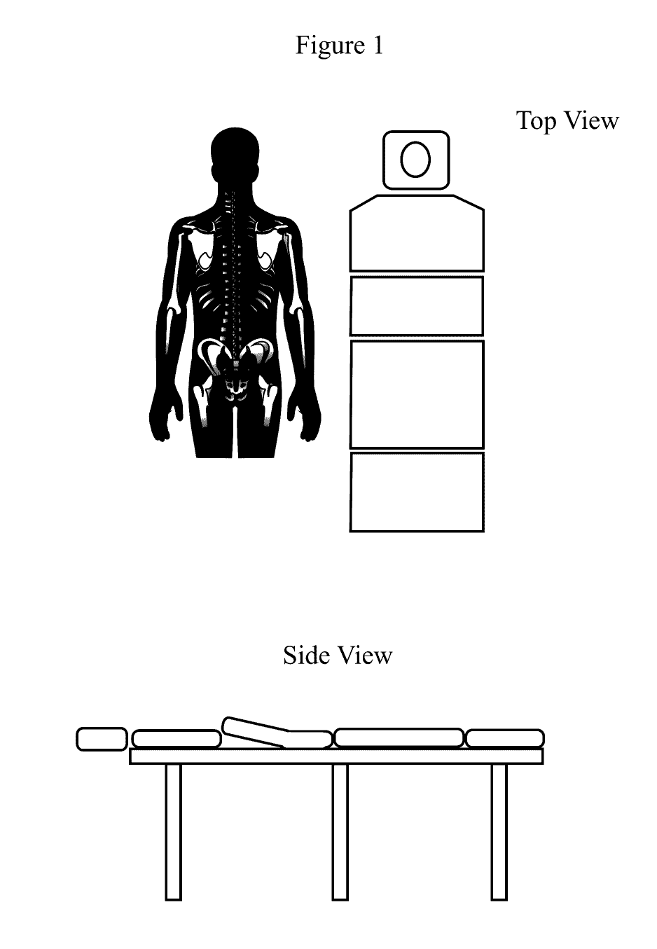

FIG. 1 is the Conventional Chiropractic Table where the separation of the table surface is Horizontal. Between the separations area the spinal cord cannot be adjusted.

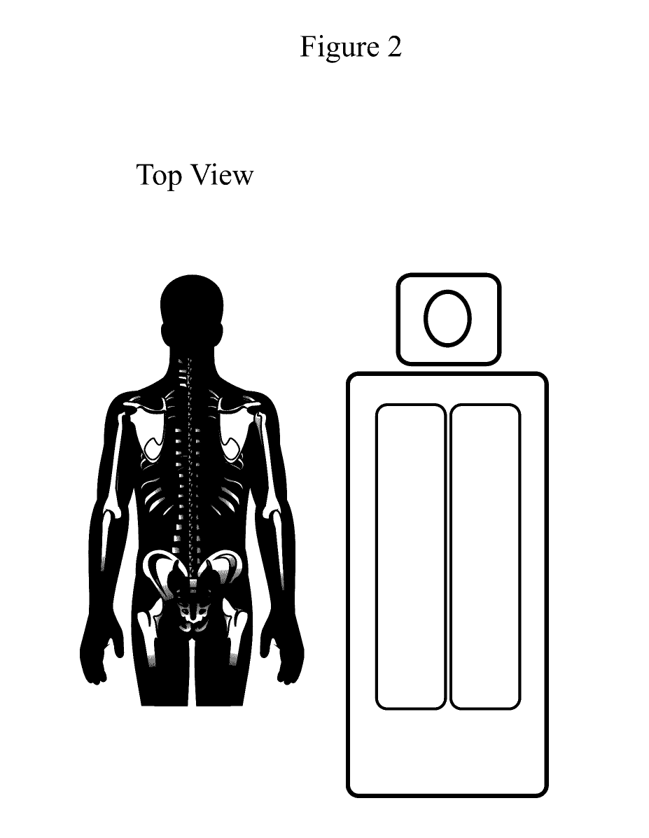

FIG. 2 is the Improved Chiropractic Table where the separation of the table surface is Vertical. The two sections will fold down inwards with adjusted pressure. When the Chiropractor will use both hands and push on your back. With the Vertical Separation, the Chiropractor will be able to adjust your entire Spin and Pelvis area. The Separation Section and the Spinal Cord are both Parallel with each other.

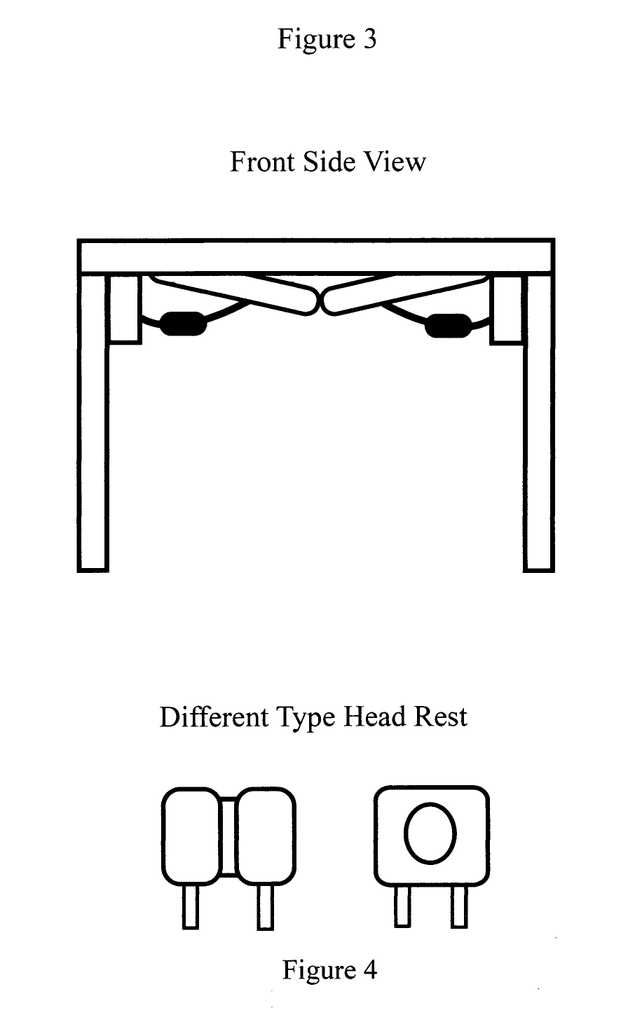

FIG. 3 is the front side view of the Improved Chiropractic Table. The two Vertical Separation Sections will fold down, inwards by the push of the Chiropractor when applying pressure on your back. The two Separation Sections are supported by adjustable spring loaded hinges. There will be four on each side. That you can obtain from the many different types of hinges available on the market. The Chiropractor will adjust the springs to the desired pressure. The result will be a much smoother action, towards your Spinal Cord, and a much safer method to adjust your Spinal Cord.

FIG. 4 is you have the option to remove the Head Rest. And install different type style Read Rest. The Patient might have a preference they like to rest on. I personally prefer the rounded shape.

1. A chiropractic table where the separation of the table surface is vertical. The two parts of the table pieces will fold down inwards. Supported by adjustable spring loaded hinges. There will be four on each side. That you can obtain from the many different types of hinges available on the market. Where the chiropractor can adjust the desired pressure that is needed to work on the patients spinal cord and pelvis area. The head rest can be removed and attach a different style head rest.

2. The two vertical separation table parts that are supported by adjustable spring loaded hinges as claimed in claim 1. Will be parallel with the spinal cord, resulting in the chiropractor will be able to adjust the entire spinal cord and pelvis area.

3. The adjustable spring loaded hinges as claimed in claims 1 and 2, when adjusted at the desired pressure by the chiropractor the result will be a smoother down ward pressure on the spinal cord and pelvis area. A much safer approach to the adjustment of the spinal cord and pelvis area.

4. The different types of head rest as claimed in claim 1, the chiropractor will be able to offer the patient the preferred head rest that they feel more comfortable to rest their heads on. By removing one head rest and attaching a different head rest shape.
